(19) United States
(12) Patent Application Publication
(10) Pub. No.: US 2024/0337040 A1
(43) Pub. Date: Oct. 10, 2024

(54) PLATING SEAL WITH IMPROVED SURFACE

(71) Applicant: Applied Materials, Inc., Santa Clara, CA (US)

(72) Inventor: Kyle M. Hanson, Kalispell, MT (US)

(73) Assignee: Applied Materials, Inc., Santa Clara, CA (US)

(21) Appl. No.: 18/298,223

(22) Filed: Apr. 10, 2023

(51) Int. Cl. C25D 17/00; B29C 64/124

(52) U.S. Cl. CPC C25D 17/004; B29C 64/124; B33Y 10/00; B33Y 70/10; B33Y 80/00; F16J 15/022

(57) ABSTRACT

The present technology includes monolithic electroplating seals, such as electroplating seals formed utilizing additive manufacturing. Seals include an external seal member and an internal seal member. The external seal member includes an inner annular radius, an outer annular radius, and an external seal member body defined between an exterior surface and an interior surface opposite the exterior surface. The exterior surface is formed from at least one polymer layer having a porosity of less than or about 10 vol. % and the external seal member body includes a filler. The internal seal member is formed integrally with and extends along at least a portion of the interior surface of the external seal member from the inner annular radius towards the outer annular radius. The internal seal member includes a deformable thermoplastic elastomer.

### TECHNICAL FIELD

The present technology relates to the production of three-dimensional objects having improved surface characteristics. The present technology relates to objects useful in electroplating systems, such as system seals that may be used to support a substrate during electroplating operations.

### BACKGROUND

Integrated circuits are made possible by processes which produce intricately patterned material layers on substrate surfaces. After formation, etching, and other processing on a substrate, metal or other conductive materials are often deposited or formed to provide the electrical connections between components. Because this metallization may be performed after many manufacturing operations, problems caused during the metallization may create expensive waste substrates or wafers.

During formation of metal materials on a wafer or substrate, a wafer may be submerged within a plating bath followed by metal formation on the wafer. The wafer may be held in place on an apparatus that submerges the wafer in a plating bath of electrolyte. The apparatus holding the wafer may include electrically conductive components contacting the wafer, allowing the wafer to operate as a cathode in the plating operation. Because the apparatus and electrical contacts may similarly be submerged within the plating bath, the apparatus may include a seal or multiple components operating as a seal to limit or prevent the electrolyte from contacting internal conductive components. These seal materials may include complex machined parts and specialized materials that may be relatively expensive.

Thus, there is a need for improved systems and components that can be used to support a substrate during electroplating operations. These and other needs are addressed by the present technology.

### BRIEF SUMMARY

The present technology is generally directed to monolithic electroplating seals, such as electroplating seals formed utilizing additive manufacturing. Seals include an external seal member and an internal seal member. The external seal member includes an inner annular radius, an outer annular radius, and an external seal member body defined between an exterior surface and an interior surface opposite the exterior surface. The exterior surface is formed from at least one polymer layer having a porosity of less than or about 10 vol. % and the external seal member body includes a filler. The internal seal member is formed integrally with and extends along at least a portion of the interior surface of the external seal member from the inner annular radius towards the outer annular radius. The internal seal member includes a deformable thermoplastic elastomer.

In embodiments, a portion of the exterior surface of the external seal member defines one or more sloped contour features. In further embodiments, the one or more sloped contour features have a slope from about 1º to about 45°. In more embodiments, the external seal member, the internal seal member, or both the external seal member and the internal seal member defines an inner sidewall at the inner annular radius, where the inner sidewall includes a sloped profile or a generally straight profile. In embodiments, the at least one polymer layer forming the exterior surface includes a thermoplastic polymer. Additionally or alternatively, embodiments include where the external seal member body include a thermoplastic polymer and from about 10 wt. % to about 50 wt. % filler, based upon the weight of the external seal member body. In further embodiments, the monolithic electroplating seal is generally free of adhesives and/or metal support member. In embodiments, the exterior surface of the external seal member includes polypropylene, the external seal member body includes glass filled polypropylene, and the internal seal member includes thermoplastic vulcanizate or styrene ethylene butylene styrene.

The present technology is also generally directed to an electroplating system seal. The system seal includes an annular busbar, an external seal member, and an internal seal member. The annular busbar defines an inner annular radius and an outer annular radius, and a plurality of contact extensions disposed along the inner annular radius. The external seal member includes an inner annular radius, an outer annular radius, and an external seal member body defined between an exterior surface and in interior surface opposite the exterior surface. The exterior surface is formed from at least one polymer layer that has a porosity of less than or about 10 vol. %, and the external seal member body includes a filler. The internal seal member is formed integrally with and extends along at least a portion of the interior surface of the external seal member from the inner annular radius toward the outer annular radius.

In embodiments, the internal seal member and the external seal member form a monolithic seal body. In more embodiments, the monolithic seal body is formed by additive manufacturing. In further embodiments, the system seal further includes a backing plate. In yet more embodiments, the annular busbar is disposed between the backing plate and at least a portion of the external seal member.)

The present technology is also generally directed to a method of making a polymeric semiconductor system component. The method includes printing a molten first feedstock on a top surface of a contoured platen, forming at least one first layer. Methods include printing a second feedstock on the at least one first layer, forming at least one second layer. Methods include where the top surface of the contoured platen defines a sloped contour feature having a slope from about 1° to about 45° and where the platen is formed from an inert material having a porosity of 10 vol. % or less.

In embodiments, methods include where the contoured platen includes a second sloped contour feature spaced apart from the first sloped contour feature, where the second sloped contour feature has a slope from about 1° to about 45°. In more embodiments, the first feedstock and the second feedstock are formed from different polymers that form a compatible interface. In further embodiments, the first feedstock and the second feedstock are formed from the same polymer, where the second feedstock further includes a filler. Additionally or alternatively, in embodiments, each first layer is printed such that each first layer includes a contoured surface that mirrors the top surface of the contoured platen. In embodiments, the molten first feedstock is printed at a temperature from about 10° to about 70° greater than a melting point of a material forming the first feedstock. In yet more embodiments, the polymeric semiconductor system component is an electroplating seal. The electroplating seal includes printing a third feedstock on a portion of the at least one second layer adjacent to an inner annular radius of the at least one second layer, where the first feedstock includes a thermoplastic polymer, and the at least one first layer has a porosity of 10 vol. % or less, the second feedstock includes a thermoplastic polymer and from about 10 wt. % to about 50 wt. % filler, based upon the weight of each second layer, and the first feedstock includes thermoplastic vulcanizate or styrene ethylene butylene styrene.

Such technology may provide numerous benefits over conventional systems and techniques. For example, the processes and systems may significantly improve surface properties of printed parts. Additionally, the processes and systems may significantly decrease surface porosity, allowing “cleaner” and stronger materials to be used, while enabling monolithic seals. These and other embodiments, along with many of their advantages and features, are described in more detail in conjunction with the below description and attached figures.

### BRIEF DESCRIPTION OF THE DRAWINGS

A further understanding of the nature and advantages of the disclosed technology may be realized by reference to the remaining portions of the specification and the drawings.

FIG. 1A shows a top perspective view of an exemplary electroplating system according to embodiments of the present technology.

FIG. 1B shows a partial cross-sectional view of a plating system according to embodiments of the present technology.

FIG. 2A shows a top perspective exploded view of a system seal assembly according to embodiments of the present technology.

FIG. 2B shows a partial cross-sectional schematic view of an electroplating system seal according to embodiments of the present technology.

FIG. 2C shows a partial cross-sectional schematic view of an electroplating system seal according to embodiments of the present technology.

FIG. 3 shows a schematic bottom plan view of an electroplating system seal according to some embodiments of the present technology.

FIG. 4 shows a partial cross-sectional schematic view of an electroplating system seal according to embodiments of the present technology.

FIG. 5 shows a schematic cross-sectional side view of an additive manufacturing apparatus according to embodiments of the present technology.

FIG. 6 illustrates operations in a method according to embodiments of the present technology.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

Electroplating operations may be performed to provide conductive material into vias and other features on a substrate. Electroplating utilizes an electrolyte bath containing ions of the conductive material to electrochemically deposit the conductive material onto the substrate and into the features defined on the substrate. The substrate on which metal is being plated operates as the cathode. An electrical contact, such as a ring or pins, may allow the current to flow through the system. During electroplating, a substrate may be clamped to a head and submerged in the electroplating bath to form the metallization. In systems as described below, the substrate may also be chucked or seated within a seal that may be coupled with the head during processing. The seal may include one or more components that engages the substrate with the electrical contacts and may limit ingression of electrolyte into the head. For example, the scal may include a structural component as well as a flexible material that produces the seal against the substrate. As several of the components of the head may be electrically conductive and in electrical communication, if electrolyte contacts these components during a plating operation, plating or deposition may occur on these components as well.

Conventional technologies often use machined materials for the structural seal components, which may be robust and/or unreactive within the plating bath. Polyether ether ketone is a common material for structural rigidity. Metal materials, including stainless steel or titanium, may also be used for some of the structural head components, although stainless steel may require coating to limit introducing iron or other materials into the bath. Coatings on these materials as well as the elastomeric material may be or include fluorine-containing materials, such as fluoroelastomers, or other cross-linked elastomers, or thermosets, which may be robust and may be inert to the electrolyte bath. However, due to the properties of many conventional elastomeric components, an additional adhesive may be required to perform the actual coupling between the structural component and the elastomeric component. The combination of materials and difficult production may cause conventional seal materials to be expensive and time-intensive to fabricate.

Attempts have been made to utilized molded seals. However, molded seals have failed to provide the combination of strength and surface finish necessary. In addition, additive manufacturing processes have been attempted for forming system seals. Additive manufacturing (AM), also known as solid freeform fabrication or 3D printing, refers to any manufacturing process where three-dimensional objects are built up from raw material (generally powders, liquids, suspensions, or molten solids) in a series of two-dimensional layers or cross-sections. However, seals and other plastic parts formed via additive manufacturing involve the incremental build up of an extruded plastic material. Thus, the exposed surfaces of such seals and plastic parts exhibit a coarse, granulated surface structure, the smoothness of which is limited by the size of the extruded material, and also exhibit a highly porous surface structure, particularly on sloped surfaces. Conversely, as noted above, system seals, as well as other plastic parts must be robust and unreactive with plating bath components, and therefore require a low-to-no porosity smooth contact surface.

The present technology overcomes these and other problems by utilizing a unique additive manufacturing process. Namely, the present technology has surprisingly found that parts and seals having high quality surfaces with one or more sloped features, can be formed by printing at least a first layer from a molten material, which will form a contact surface (also referred to as the exterior surface) of the part, against a platen having a high degree of smoothness and a desired contour. For instance, by utilizing pre-determined temperatures with targeted materials, one or more layers can be formed over a contoured surface in a manner that imparts the surface properties of the contoured surface to a contact surface of the part or seal. Thus, the present technology provides for the formation of parts and seals having low-to-non porous contact surfaces even when the surface is not linear across the entirety of the surface. Moreover, such a process allows for the incorporation of materials that are less expensive, less reactive with electrolytic baths, do not require adhesives, and/or the incorporation of more than one material, while forming a unitary component body.

Although the remaining disclosure will routinely identify specific electroplating processes utilizing the disclosed technology, it will be readily understood that the systems and methods are equally applicable to other polymeric parts and seals in plating chambers and systems, as well as processes as may occur in the described systems and other semiconductor systems. Accordingly, the technology should not be considered to be so limited as for use with these specific plating processes or systems alone. The disclosure will discuss one possible system that may include electroplating components according to embodiments of the present technology before additional variations and adjustments to this system according to embodiments of the present technology are described.

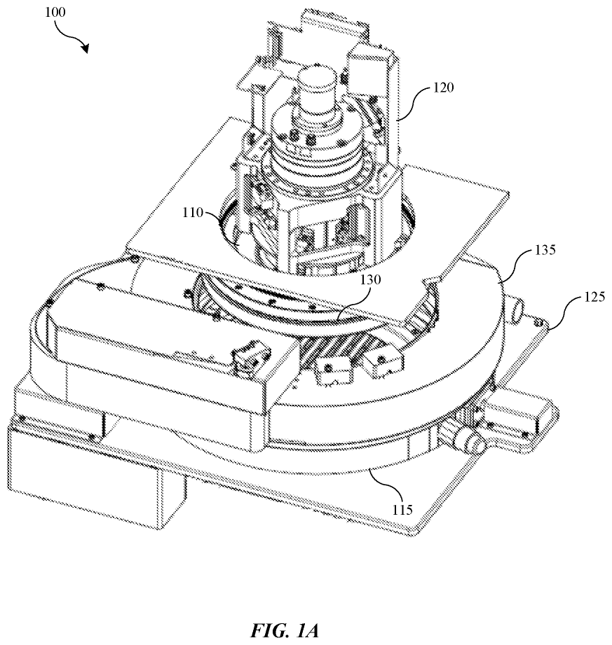

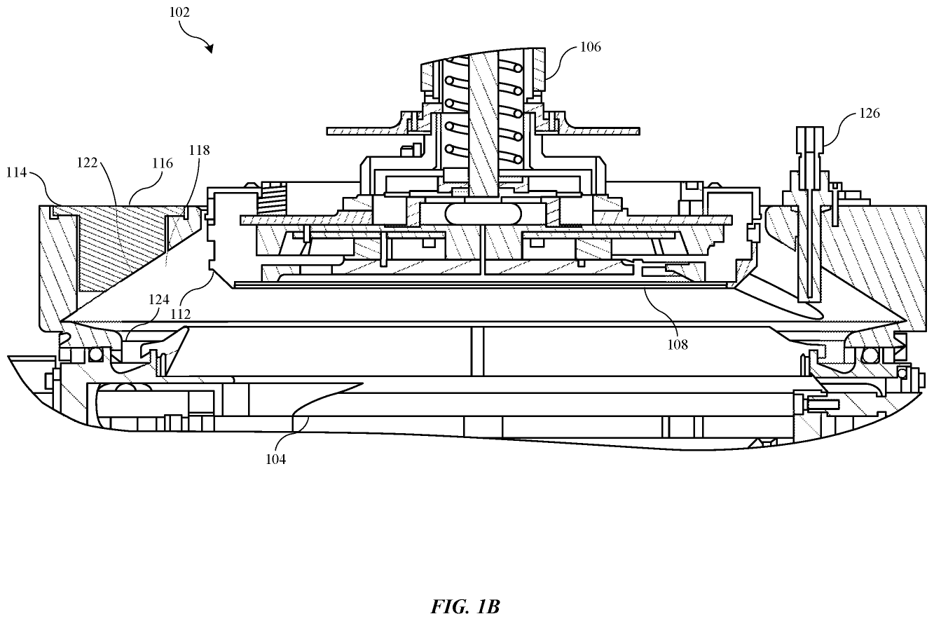

FIG. 1A shows a schematic perspective view of a plating system 100 that can perform plating methods according to embodiments of the present technology. Plating system 100 may be operable to perform both electroplating operations and electroless plating operations. In electroplating operations, the plating system 100 delivers an electric current to a substrate so that ions in an electroplating bath in contact with the substrate may be reduced and plated on the substrate. In electroless plating operations, the plating system 100 does not deliver an electric current to the substrate. Instead, the plating relies on the spontaneous reduction of ions in the plating bath when they contact surfaces of the substrate that include a material that has a lower standard electrode potential (E°) than the ions. Plating system 100 illustrates an exemplary plating system, including a system head 110 and a bowl 115. During plating operations, a wafer may be clamped to the system head 110, inverted, and extended into bowl 115 to perform a plating operation. Plating system 100 may include a head lifter 120, which may be configured to both raise and rotate the head 110, or otherwise position the head within the system, including tilting operations. The head and bowl may be attached to a deck plate 125 or other structure that may be part of a larger system incorporating multiple plating systems 100, and which may share electrolyte and other materials. A rotor may allow a substrate clamped to the head to be rotated within the bowl or outside the bowl in different operations. The rotor may include a contact ring, which may provide the conductive contact with the substrate.

A system seal 130 discussed further below may be connected with the head. Seal 130 may include a chucked wafer to be processed. FIG. 1A illustrates a plating system 100 that may include components to be cleaned directly on the platform. In embodiments, the plating system 100 further includes an in situ rinse system 135 for component cleaning. In additional embodiments (not shown) a plating system may be configured with a platform on which the head may be moved to an additional module where a seal or other component cleaning is performed.

FIG. 1B shows a partial cross-sectional view of a plating chamber that includes a plating apparatus 102 according to some embodiments of the present technology. The plating apparatus 102 may be incorporated with a plating system, including system 100 described above. As illustrated in FIG. 1B, a plating bath 104 of a plating system is shown along with a head 106 having a substrate 108 coupled with the head. In the embodiment shown, a substrate is coupled with a seal 112 incorporated on the head 106. A rinsing frame 114 may be coupled above the plating bath vessel 104 and may be configured to receive the head 106 into the vessel during plating. Rinsing frame 114 may include a rim 116 extending circumferentially about an upper surface of the plating bath vessel 104. A rinsing channel 118 may be defined between the rim 116 and an upper surface of the plating bath vessel 104. For example, rim 116 may include interior sidewalls 122 characterized by a sloping profile. Rinse fluid slung off a substrate may contact the sidewalls 122 and may be received in a plenum 124 extending about the rim for collection of the rinse fluid from the plating apparatus 102. In embodiments, plating apparatus 102 may additionally include one or more cleaning components. The cleaning components may include one or more nozzles used to deliver fluids to or towards the substrate 108 or the head 106. In additional embodiments, a side clean nozzle 126 may extend through the rim 116 of the rinsing frame 114 and be directed to rinse seal 112, along with aspects of substrate 108.

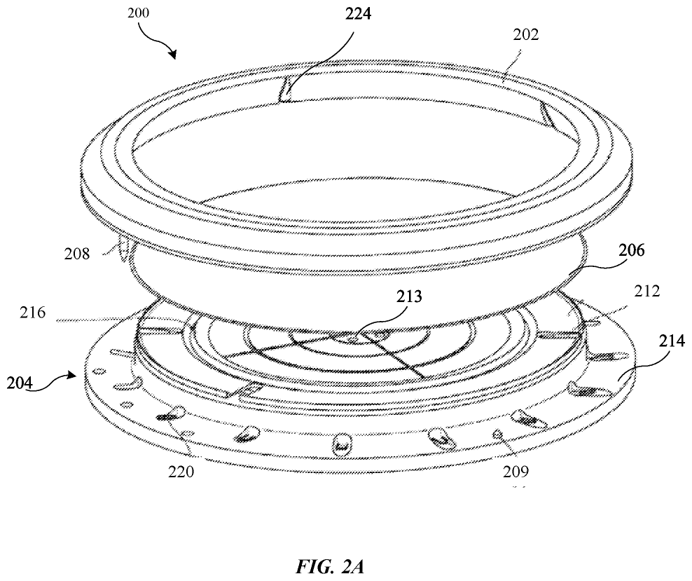

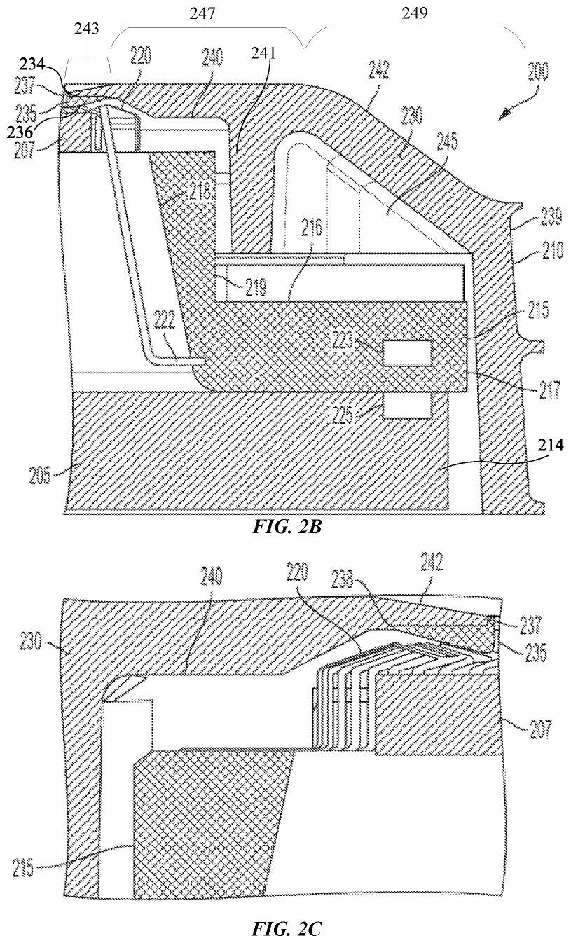

Nonetheless, in embodiments, the seal, such as one or more of seals 112 and/or 130 discussed above may be an electroplating system seal 200. As illustrated in FIG. 2A, the system seal assembly 200 includes a seal 202 and a backing plate 205, configured to releasably retain a substrate 206 therebetween for processing. However, it should be clear that other configurations as known in the art may be utilized. For instance, in embodiments, as will be discussed in greater detail below, seal 202 may include a retaining ring formed from a different material, such as a non-plastic material. Nonetheless, as illustrated, in embodiments, sealing assembly 202 may include one or more centering pins 208. In further embodiments, backing plate assembly 204 may include one or more chucking pins 220 and/or one or more sealing assembly location pins 209, and a substrate support surface 212. In embodiments, substrate support surface 212 may contain a seal 216 for contacting a backside surface (e.g. surface opposite the working surface that contacts the plating bath liquid) of the substrate 206 and a base 214. The backside seal 216 between the substrate support surface 212 and the backside of substrate 206 may include vacuum pressure utilizing one or more vacuum ports 213.

FIG. 2B shows a partial cross-sectional schematic view of an electroplating system seal 200 according to some embodiments of the present technology. System seals 200 according to the present technology may include multiple components that may be joined to produce the system seal for supporting and holding a substrate during electroplating. For instance, system seal 200 can include a backing plate 205, a seal member 210, and/or busbar 215, as well as other components as known in the art. However, as discussed above, the seal member 210 according to the present technology is a monolithic body, eliminating the need for adhesives and non-polymeric strengthening members, improving the sealing surface of the seal body 210. Regardless, the system seal 200 includes a backing plate 205 which may include a portion 207 on which a substrate may be positioned and engaged by the seal member 210 (as illustrated more clearly by support surface 212 in FIG. 2A). The backing plate 205 may also include a base 214 to which the seal may be coupled via busbar 215 and/or outer sidewall 239. In some embodiments the backing plate, busbar, and seal may all be coaxially aligned about a central axis extending vertically through the system seal 200 as illustrated more clearly in FIG. 2A.

Busbar 215 may be an annular component and may include one or more pieces connected together. The busbar may be characterized by an outer sidewall 217 at an outer annular radius of the component. The busbar 215 may also be characterized by an inner annular radius that may be defined by an inner sidewall 218 of the busbar, or by a component extending from the inner sidewall 218 of busbar 215. For example, busbar 215 may include a plurality of contact pins 220 disposed along the inner annular radius and extending inward from inner sidewall 218 towards the central axis. The contact pins 220 may be included in any spacing or orientation to provide uniform or directed contact to a substrate against which the electrical contacts are engaged. Although termed contact pins, contact pins 220 may be shaped in a variety of forms, and may be contact extensions or conductive extensions, which may include looped features in some embodiments to limit any piercing contact with a substrate. The contact pins may be coupled with or extend from an upper surface of the busbar 215 as illustrated in some embodiments.

Additionally, one or more support members 222 may extend from the inner sidewall 218, and extend past the upper surface of the busbar to interact with the contact pins 220. The support members 222 may be distributed radially about the busbar 215, and may be configured to facilitate centering and support of a substrate incorporated with the system seal 200. The busbar 215 may receive current through the contact pins 220 forming an electrode with the substrate, which may operate as the cathode on which a reduction reaction and electrical plating may occur. Busbar 215 may form a lateral base 214 proximate the outer annular radius, and with which the backing plate may be coupled. Busbar 215 may extend vertically towards the inner annular radius, and may form a neck 219 region towards the interior, which may define a frustum volume within the inner sidewall, although other cylindrical or geometric forms may similarly be formed.

The two or more components of the seal may be removably coupled in some embodiments allowing separation of the components for delivery and removal of a substrate. The coupling may occur by any number of means including mechanical coupling with bolts, screws, or other devices configured to join two components. The coupling may also be with magnets included within the busbar 215 and the backing plate 205. For example, a first plurality of magnets 223 may be disposed within busbar 215 and a second plurality of magnets 225 may be disposed within backing plate 205. When aligned, the magnets may attract one another and join the backing plate with the busbar. Overcoming the magnetic force of the magnets may afford decoupling of the two portions of the seal.

The seal member 210 of the system seal 200 may form an enclosure about portions of the busbar and backing plate that may be exposed to an electroplating solution. The seal member 210 may be coupled with the busbar 215 in a number of ways, and may be bolted or otherwise mechanically coupled with the busbar. The coupling may include adhesive or other irreversible couplings, although in some embodiments the coupling may be a reversible coupling, such as with screws, bolts, or other mechanical fasteners, such as via one or more mounting holes 224 (FIG. 2A), allowing the busbar 215 to be removed from seal member 210. Seal member 210 may include an external seal member 230 and an internal seal member 235 in some embodiments. However, as discussed above, the external seal member 230 and the internal seal member 235 are part of monolithic seal member 210, and may therefore be formed in a unitary manner according to the methods and systems herein, and may be referred to as an external seal member 230 and internal seal member 235 for orientation purposes only.

External seal member 230 may be an annular component extending about a central axis through the system seal 200. External seal member 230 may be characterized by an inner annular radius at an inner sidewall 237. External seal member 230 may also be characterized by an outer annular radius at an outer sidewall 239. Seal member 210, and specifically external seal member 230 may extend inward of and outward of the busbar 215 and/or backing plate 205 of system seal 200. For example, inner sidewall 237 may extend radially inward of the contact pins 220 at the inner annular radius of the external seal member 230. An inner portion of the external seal member 230 may also be vertically aligned with the contact pins 220, which may position internal seal member 235 in close proximity to contact pins 220 affording a more complete or fully complete seal with a substrate positioned between the internal seal member and the contact pins.

External seal member 230 may include a number of features and surfaces in embodiments. For example, external seal member 230 may include an interior surface 240 extending along a radial length of the external seal member 230 and defining a number of features of the external seal member 230. The interior surface 240 may be at least partially facing the contact pins 220, such as proximate an interior region of the external seal member 230. External seal member 230 may also include an exterior surface 242, which may be a surface opposite the interior surface 240, and an external seal member body 241, in some embodiments. In embodiments, exterior surface 242 may define one or more contours or tapers.

For instance, referring to FIG. 2B, at the inner annular radius, inner sidewall 237 may define an external seal member height between the interior surface 240 and the exterior surface 242 of the external seal member 230. In some embodiments, the external seal member 230 may be characterized by a height, which may correspond to a thickness of the external seal member 230/the external seal member body 241 at an inner radius, of less than or about 1 cm, and in embodiments the height of inner sidewall 237 may be less than or about 9 mm, less than or about 8 mm, less than or about 7 mm, less than or about 6 mm, less than or about 5 mm, less than or about 4 mm, less than or about 3 mm, less than or about 2 mm, less than or about 1 mm, less than or about 0.5 mm, or less in some embodiments.

However, a first portion 243 of the exterior surface 242 adjacent to, or starting at, inner sidewall 237 and extending towards outer sidewall 239 may extend along a sloped profile (e.g. a portion along the exterior surface 242 that contains one or more points that are not co-linear with one or more other portions of exterior surface 242, such as second portion 247). For instance, while it should be clear that a taper as a sloped profile may be generally straight (e.g. generally consistent slope) across the tapered portion, such as a first portion 243 of exterior surface 242 adjacent to inner sidewall 237, the tapered portion contains one or more points that lay on a line that is not co-linear with one or more points on a second portion of the exterior surface. Further, a portion having a contoured sloped profile, such as third portion 249, may exhibit a change in slope at various points within the portion, defining one or more tangent lines that are non co-linear with one another and/or with or more other portions of exterior surface 242 (such as second portion 247).

Nonetheless, in embodiments, the sloped profile or first portion 243 may end in a plane generally aligned with an apex of one or more contact pins 220. Thus, in embodiments, the external seal member body 241 may have a thickness at a distal end of first portion 243 (e.g. end aligned with an apex of one or more contact pins 220) greater than a thickness at inner sidewall 237. However, in embodiments, the external seal member body 241 may have a generally uniform thickness in the first portion 243, second portion 247 and/or third portion 249, which may be any portion between the first portion adjacent to inner sidewall 237 and third portion 249 adjacent to outer sidewall 239. Of course, it should be understood that, in embodiments, the external seal member 230 may have any number of portions which may vary in thickness. However, in embodiments, when travelling from an inner sidewall 237 to outer sidewall 239 along exterior surface 242, the thickness may increase through the first portion 243 and second portion 247, until the third portion 249 where the at least a second taper or contour is encountered. In embodiments, no second taper or counter may be defined on the exterior surface, or more than two additional tapers or contours may be defined.

Regardless, it should be understood that exterior surface 242 may define one or more sloped profiles at one or more tapers or contours, and further, that such tapers or contours may have a consistent slope for the entirety of the respective contour or may have increasing or decreasing slopes along the contour or taper. As an example only, as tapers and contours discussed herein may have any number of shapes and slopes, the taper illustrated adjacent to inner sidewall 237 in first portion 243 of FIG. 2B may have a generally consistent slope, whereas a taper or contour disposed adjacent to outer sidewall 239 in third portion 249 may define a first and second end of the tapered or contoured portion with a relatively smaller slope that gradually increases, reaches a midpoint, and then decreases back toward the original slope.

External seal member 230 may include features to accommodate busbar 215. For example, external seal member 230 may be characterized by a profile along interior surface 240 configured to accommodate components of system seal 200. In one embodiment, with some aspects as illustrated, interior surface 240 may be characterized by a slope profile extending radially outward from inner sidewall 237, which may be similar to an angle of slope of contact pins 220. As will be described below, in some embodiments, an initial portion of the interior surface 240 of external seal member 230 may extend flat while an internal seal member 235 may form the initial sloping profile of the seal member 210. Interior surface 240 may then be characterized by a reversed slope similar to contact pins 220 as the pins extend back towards busbar 215.

As external seal member 230 extends past a neck 219 portion of busbar 215 to the lateral base 214, the interior surface 240 of external seal member 230 may extend vertically towards a recessed ledge formed by busbar 215 between the neck 219 portion and the base 214 portion. The interior surface 240 of external seal member 230 may extend radially outward in a parallel, or also in a relatively lateral direction, past outer sidewall 217 of busbar 215. A channel may be formed within such a midsection of the external seal member as will be explained further below, and partitions 245 may extend across or intersect the channel at radial locations about the channel. However, in embodiments, no channel or partitions may be present. External seal member 230 may then extend vertically past busbar 215 and continue to extend past a height commensurate with backing plate 205. Because external seal member 230 may extend vertically beyond the conductive and other system seal 200 components, external seal member 230 may ensure that electrolyte cannot contact these components during plating operations.

Moreover, internal seal member 235 may be formed integrally with an interior portion of external seal member 230 proximate inner sidewall 237. Namely, in embodiments, internal seal member 235 may form all of inner sidewall 237, or may form a portion of the inner sidewall 237 in combination with external seal member 230. Internal seal member 235 has a top surface 234 formed adjacent to interior surface 240 and a lower surface 236 that forms a lower surface of the seal or that is formed adjacent to contact pin 220 when part of a system seal. As discussed above, internal seal member 235 may have a sloped profile at lower surface 236 opposite the interior surface 240 of external seal member 230. Namely, internal seal member 235 may have a larger thickness adjacent to inner sidewall 237 that decreases in thickness (a height between top surface 234 and lower surface 236) extending towards outer sidewall 239. While a contoured sloped profile is illustrated for internal seal member 235, it should be understood that other slopes may be utilized for the sloped profile, including stepped profiles and tapered profiles. As shown, in embodiments, the inner sidewall 237, whether formed from external seal member 230, internal seal member 235, or a combination thereof, may have a generally straight profile and extends perpendicularly to a planar portion of exterior surface 242 (such as second portion 247). However, it should be understood that, in embodiments, the inner sidewall 237 may also having one or more portions containing a curved or tapered profile (relative to a plane perpendicular to a coplanar portion of exterior surface 242 unlike the profile of exterior surface 242 discussed above).

FIG. 2C shows a detailed partial cross-sectional schematic view of an electroplating system seal 200 according to some embodiments of the present technology. System seal 200 may include some or all of the previously described components including a portion 207 of a backing plate described above, and on which a substrate may be at least partially supported. Busbar 215 may support contact pins 220 from a neck portion of busbar 215, which may be positioned within a volume defined by external seal member 230. External seal member 230 may include an interior surface 240 and an exterior surface 242 (also referred to as the contact surface) as previously described. Internal seal member 235 may be formed integrally with external seal member 230 proximate inner sidewall 237 of external seal member 230. Internal seal member 235 may be positioned between a radially inward most portion of external seal member 230 and contact pins 220. Internal seal member 235 may extend partially along interior surface 240 of external seal member 230 from inner sidewall 237 along a first distance, which may be less than or about 3 cm, and in some embodiments may be less than or about 2 cm, less than or about 1 cm, less than or about 9 mm, less than or about 8 mm, less than or about 7 mm less than or about 6 mm, less than or about 5 mm, less than or about 4 mm, less than or about 3 mm, less than or about 2 mm, or less.

As illustrated, internal seal member 235 may be characterized by a taper extending from inner sidewall 237. The angle of taper may be less than or about an angle of an end portion of contact pins 220. However in embodiments, other sloped profiles may be utilized, such as stepped or graded tapers, that form a seal with contact pins 220. Because of this formation, in some embodiments interior surface 240 of external seal member 230 may extend laterally from inner sidewall 237, and may not be characterized by a slope where internal seal member 235 may be located. Additionally, a recessed ledge 238 may be formed in external seal member 230 at an edge of the coupling position. However, due to the improved adhesion utilizing the present technology, no recessed ledge may be necessary in embodiments. Interior surface 240 of external seal member 230 may continue laterally, or may continue a slope formed radially inwardly by internal seal member 235. The slope may continue to a position configured to maintain a gap spacing to support a substrate against a zenith formed by contact pins 220. For example, contact pins 220 may include a bent structure characterized by a zenith position against which a substrate may be positioned. An outer radial edge of the substrate may extend slightly beyond the contact pin, and external seal member 230 may maintain a gap spacing to accommodate the substrate that may be slightly radially outward of the highest position of the contact pins 220.

The internal seal member may be or include a deformable or compressible material, and may be configured to support a substrate between the internal seal member and the plurality of contact pins 220. In compression or deformation, the internal seal member may form a substantially, essentially, or otherwise complete seal between the internal seal member 235 and a supported substrate, which may ensure electrolyte fluid may not flow within system seal 200, or interact with contact pins 220, busbar 215, or other internal components of the head assembly on which system seal 200 may reside.

As illustrated, in some embodiments internal seal member 235 may extend radially inward of the external seal member 230. However, in embodiments, such an extension may not be necessary due to the improved adhesion of the monolithic body. Thus, the internal seal member 235 may have an inner surface generally coplanar with inner sidewall 237 of external seal member 230. The internal seal member 235 may also extend vertically along inner sidewall 237, and may extend along a full height of inner sidewall 237 in embodiments. Although in some embodiments internal seal member 235 may extend along exterior surface 242 of external scal member 230, in some embodiments the external seal member may be maintained substantially free of the internal seal member material along the exterior surface of the external seal member 230 and/or along inner sidewall 237 of the external seal member 230.

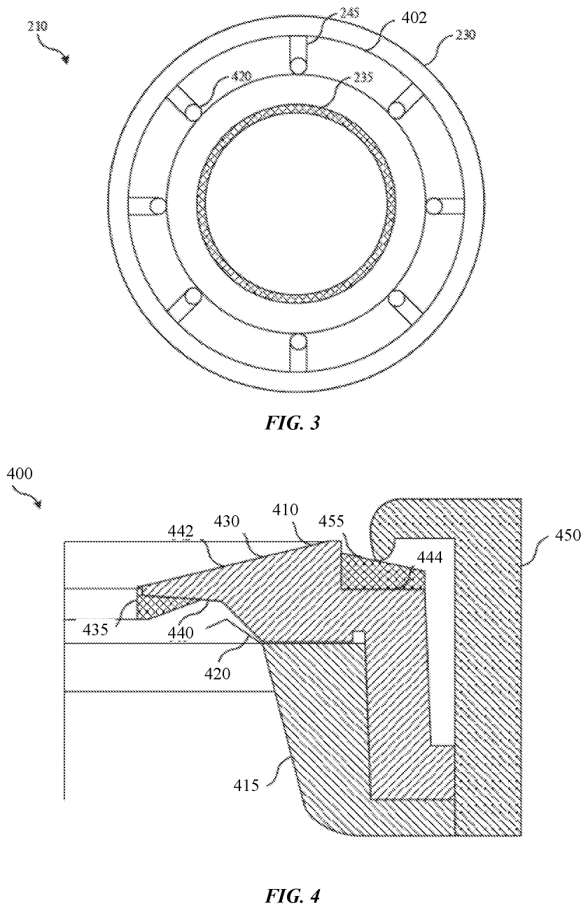

FIG. 3 shows a schematic bottom plan view of an electroplating seal member 210 according to some embodiments of the present technology. Seal member 210 may include any of the components previously described, and may illustrate a view with busbar 215 removed. Seal member 210 may illustrate a view of external seal member 230 and internal seal member 235. As noted previously, a channel 402 may be formed radially along a midsection of external scal member 230, such as along a location where external seal member 230 extends vertically towards a base of a busbar, which may have transitioned from a neck region. This may cause increased thickness through the midsection. Forming channel 402 may maintain a more controlled thickness across the external seal member.

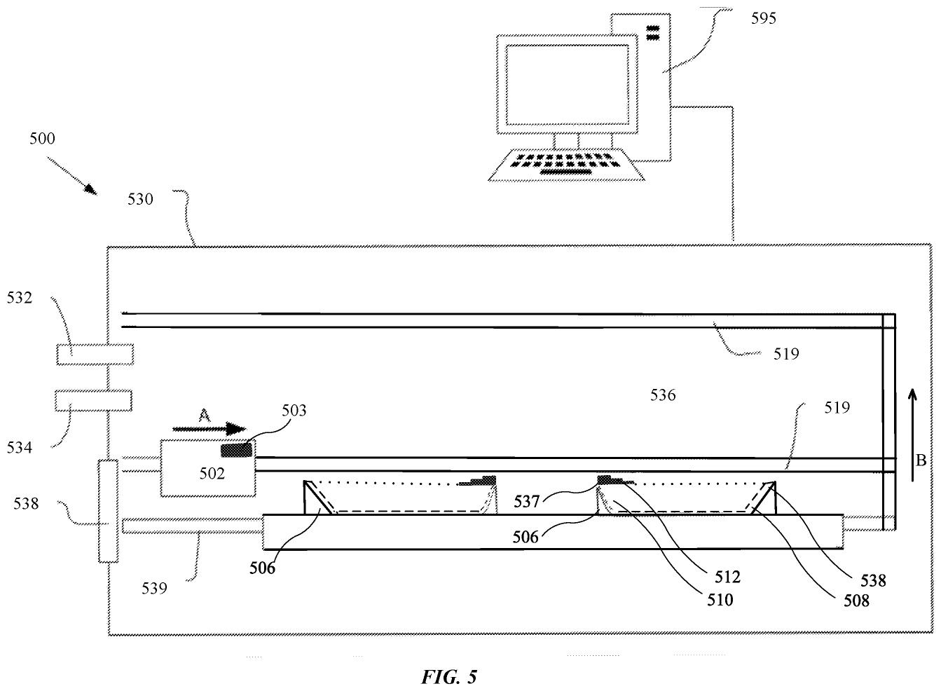

Turning to FIG. 4 is shown a partial cross-sectional schematic view of an electroplating system seal 400 according to some embodiments of the present technology. System seal 400 may be similar to system seal 200 previously described and may include any of the components, materials, or characteristics described above. System seal 400 may also illustrate a seal that may be incorporated in systems having an additional or external retaining member. System seal 200 may illustrate a single seal design in which external seal member 230 fully encompassed or extended about busbar 215. Accordingly, the location for electrolyte ingress where a seal may be maintained was at the substrate, and with internal seal member 235. In other designs an external seal member may not extend about an associated busbar, such as illustrated in FIG. 5. Accordingly, an additional seal location may be incorporated in the design.

As noted system seal 400 may include similar components as described previously, and may include a seal member 410 and a busbar 415. Contact pins 420 may extend from an upper surface of busbar 415. Seal member 410 may include an external seal member 430 and an internal seal member 435 as previously described. In some embodiments seal member 410 may not extend radially outward of and about busbar 515. Accordingly, an outer radial edge of busbar 415 may be potentially exposed to electrolyte during plating operations. An external retaining member 450 may be included to provide an additional seal against electrolyte contact with busbar 415.

External retaining member 450 may be made of a number of materials compatible with electrolytes used in electroplating operations, and may be insulative as previously described. External retaining member 450 may be any of the materials noted above. However, in embodiments, the external retaining member 450 may be formed from a polymeric material and/or may be formed integrally with seal member 410. Namely, as noted above, the methods and processes according to the present technology provide for the formation of monolithic seals, eliminating the need for adhesives and metal supports, such as traditional metal and/or metal coated retaining rings.

To form a seal to protect an outer edge of busbar 415, a similar sealing material may be used at an exterior location as at the interior location where a substrate may be positioned. As illustrated, material 455 may be formed on external seal member 430 to provide a seal location for external retaining member 450. External seal member 430 may include an interior surface 440 along which internal seal member 435 may be at least partially located. External scal member 430 may also include an exterior surface 442. The external seal member 430 may define a recessed ledge 444 along the exterior surface. An amount of material 455 may be formed or disposed within the recessed location and configured to form a liquid seal with external retaining member 450. Material 455 may be the same or a different material as used in internal seal member 435, and may be any of the previously described materials. When similar to the material for internal seal member 435, material 455 may similarly be formed integrally with external seal member 450.

Nonetheless, it should be clear that other orientations of the seal, busbar, and retaining ring, as well as the elimination of a retaining ring, are contemplated by the present technology, as well as other seals and semiconductor components that have a contact surface.

Namely, as discussed above, the present technology has surprisingly found that by utilizing additive manufacturing and printing at least a first layer on a platen having a desired sloped surface profile and surface characteristics, a working surface, such as exterior surface 242 is formed with excellent surface properties. Namely, unlike conventional additive manufacturing processes and products, the exterior surface 242 exhibits a finish that closely mirrors the surface of the platen. Therefore, by carefully selecting the platen material and sloped surface profile, as well as the manufacturing temperature and material, a seal or component can be formed via additive manufacturing that has an excellent surface finish, such as low porosity.

For instance, in embodiments, the exterior surface, which may include one or more layers as discussed in greater detail below, may have a porosity of about 10 vol. % or less, such as about 9 vol. % or less, such as about 8 vol. % or less, such as about 7 vol. % or less, such as about 6 vol. % or less, such as about 5 vol. % or less, such as about 4 vol. % or less, such as about 3 vol. % or less, such as about 2 vol. % or less, such as about 1 vol. % or less, such as about 0.5 vol. % or less, such as about 0.1 vol. % or less, or any ranges or values therebetween. Moreover, in embodiments, the exterior surface layer(s) may be generally free of pores. Porosity, as used herein may be defined by the volume of the pores or voids based upon the volume of the layer(s). For instance, a pore may define a void in the layer(s), where the void space has a volume, and where such a volume is not occupied by the layer material. Thus, a pore or plurality of pores, when present, occupy a portion of the layer(s) volume.

In general, an additive manufacturing system can include a platen to receive feed material, a feed material dispenser, and one or more heat sources that can heat the feed material(s). The heat sources can include a beam source, a heat lamp array, and/or resistive heater coils that are embedded in the platen. Components of the additive manufacturing system can move relative to one another or in conjunction with one another (i.e., are fixed relative to each other in operation) as they traverse across the platen to deposit, fuse and cool, respectively, the feed material(s).

For instance, FIG. 5 illustrates a side view of an exemplary additive manufacturing system 500. In exemplary embodiments, the construction of a seal or other polymeric semiconductor component discussed herein may begin by creating a CAD model, or other computer model, of the three dimensional version of the seal or component. An output file is generated and rendered via controller 195, and the 3D model is then “sliced” into a series of 2D data bitmaps, or pixel charts. The 2D bitmaps, or pixel charts, are used to define the locations across an X and Y plane where the layers in the heat exchanger will be built. In this configuration, the additive manufacturing process will use these locations to define where a laser will be applied to form the desired layer features. Every coordinate for an X and Y location and a given heat exchanger supporting Z stage position will be defined based on the pixel charts. By combining the pixel charts in each formed layer, a component of a desirable shape and structural configuration can be printed by the additive manufacturing system 500.

Nonetheless, additive manufacturing system 500 includes a printhead 502 having a heater 503 and a build platen 504 (e.g., a platen) having one or more features 506. In embodiments, the printhead 502 and the platen 504 can both be enclosed in a housing 530 that forms a sealed chamber 336, e.g., a vacuum chamber, that provides a controlled operating environment. The chamber 536 can include an inlet 532 coupled to a gas source and an outlet 534 coupled to an exhaust system, e.g., a pump. However, in embodiments, no chamber or controlled operating environment is necessary or utilized. If a chamber is utilized, regardless of a controlled environment, load door 538 may provide access to the platen 504, such as by rail 539.

As discussed above, the present disclosure has surprisingly found that by utilizing a platen 504 with one or more sloped features 506, the first deposited material layer, which forms the external surface or contact surface of the finished component, may have markedly different surface properties than conventional seals or components formed by additive manufacturing. For instance, in embodiments, the platen 504, including sloped features 506 may be formed from a material having a high degree of smoothness and low-to-no porosity (such as any of the porosity values discussed above) in order to impart such a surface on the exterior layer(s) of the seal or component. Thus, in embodiments, the platen 504 and/or features 506 may be formed from an inert material having a high degree of smoothness and low-to-no porosity, such as ceramic, glass, a metal, or a combination thereof.

Moreover, while two sloped features 506 are shown in a spaced-apart orientation, it should be clear that in embodiments, only one feature may be utilized, or that greater than 2 features may be contained on platen 504, such as greater than or about 3, such as greater than or about 4, such as greater than or about 5, such as greater than or about 7, such as greater than or about 10, such as greater than or about 15, such as greater than or about 20, or any ranges or values therebetween. Additionally or alternatively, while FIG. 5 illustrates a cross-sectional view, it should be clear that the features 506 may extend annularly around platen 504 so as to form annular lines, grooves, ridges, or the like. Thus, in embodiments, the features illustrated in FIG. 5 may form an annular ridge around platen 504 corresponding in width or diameter to inner sidewall 237 and/or outer sidewall 239. Moreover, it should be clear that, in embodiments, any number, shape, and size of features 506 may be utilized to form any one or more of the sloped profiles discussed in regards to FIGS. 2A-2C. In addition, features 506 may extend for varying horizontal lengths and contain variations in slope, in order to form one or more portions of a component having various sloped profiles.

As may be clear from the above discussion, the feed material utilized herein is applied to platen 504 in a molten or liquid state. Namely, applications utilizing a molten feed are necessary for the deposited feed material to closely mirror the contours and surface properties of the platen 504. Thus, in embodiments, the feed material of at least a first layer (e.g. the one or more layers deposited on platen 504 containing features 506) of the present technology may be applied at a temperature above a melting point of the feed material, but not significantly above so as to avoid running of the material, such as a temperature of at least about 5° C. above the selected feed material's melting point, such as greater than or about 7.5° C., such as greater than or about 10° C., such as greater than or about 12.5° C., such as greater than or about 15° C., such as greater than or about 20° C., such as greater than or about 25° C., such as greater than or about 30° C., or any ranges or values therebetween.

Moreover, it should be clear that the one or more first layers are applied in one or more layer(s) that mirror the surface profile of the feature 506 containing platen 504. Namely, conventional additive manufacturing processes, form consecutive horizontal layers on top of a previous layer. Thus, the outer edges of the part exhibit a granulated or pixilated surface due to the printing limitations of the additive manufacturing nozzle. Conversely, the present technology has found that by printing a first layer across an entirety of a surface having a sloped profile in a molten state (see, e.g., one or more first layers 508 which are printed to mirror feature 506 containing platen 504, including the sloped profile, instead of building the shape utilizing multiple horizontal layers of varying widths), the one or more first layers form an exterior surface of the component that has excellent properties across the entirety of the exterior surface.

In addition, in embodiments, the platen 504 as well as the one or more features 506 may be heated in order to allow formation of a smooth layer prior to cooling of the feed material. Thus, in embodiments, the platen 504 and features 506 may be heated to a temperature of greater than or about 30° C., such as greater than or about 40° C., such as greater than or about 50° C., such as greater than or about 60° C., such as greater than or about 70° C., or any ranges or values therebetween.

Nevertheless, surprisingly, the present specification has found that by utilizing compatible materials with the processes and methods described herein, two or more different materials may be utilized in printing the seal or component. Thus, unlike conventional seals, a monolithic seal may be formed having improved properties, such as improved surface uniformity and strength, from two or more compatible materials.

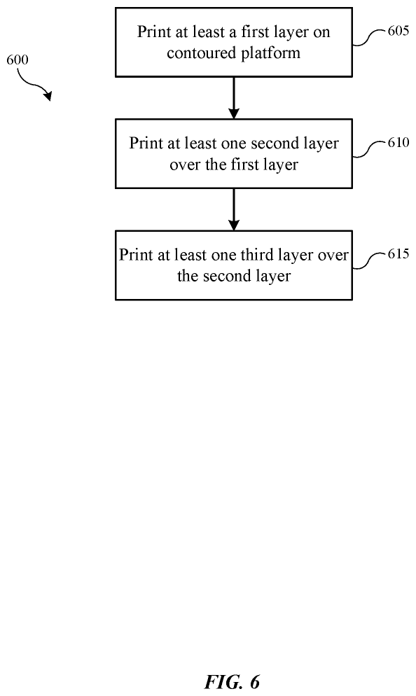

For instance, FIG. 6 shows operations of an exemplary method 600 of forming a seal or component according to embodiments of the present technology. The method 600 may also include one or more operations prior to the initiation of the method. The method may further include a number of optional operations, which may or may not be specifically associated with some embodiments of methods according to the present technology. For example, many of the operations are described in order to provide a broader scope of the processes performed but are not critical to the technology or may be performed by alternative methodology, as will be discussed further below.

Method 600 may include operations described in the apparatus of FIG. 5, as discussed herewith. For instance, in embodiments, the printhead 502 dispenses a first feed material, forming one or more first layers 508 against a top surface 505 of the platen 504 and features 506 at operation 600. In embodiments, the printhead 502 is configured to traverse the platen 504 (shown by arrow A). For example, the additive manufacturing system 500 can include a support, e.g., a linear rail or pair of linear rails 519, along which the printhead can be moved by a linear actuator and/or motor. This permits the printhead 502 to move across the platen 504 along one or more horizontal axis. The printhead 502 is also movable along a vertical axis (shown by arrow B) in order to follow the outline of the contour when depositing the one or more first layers. In particular, the printhead 502 can be lifted by an amount equal to the change in height of the platen 504 and/or features 506 in order to deposit an even layer having a surface profile that matches the platen 504 and features 506. This can maintain a constant height difference between the dispenser on the printhead and the top of the platen 504 including features 506 and/or the immediately preceding layer of deposited feed material. A drive mechanism, e.g., a piston or linear actuator, can be connected to the printhead or support holding the printhead to control the height of the printhead. Alternatively, the printhead 502 can be held in a fixed vertical position, and the platen 504 can be raised and lowered.

Regardless of the number of features and the orientation of such feature in the contoured design, it should be clear from the above description that the features are limited in slope and change in slope values in order to maintain a constant height difference. Thus, in embodiments, while the one or more features can have a variety of shapes, the maximum printed slope angle between adjacent layers is no greater than about 45°.

In embodiments, one or more first layers 508 of the first feedstock material may be printed until a thickness of greater than or about 0.01″ is obtained, such as greater than or about 0.02″, such as greater than or about 0.03″, such as greater than or about 0.04″, such as greater than or about 0.05″, such as greater than or about 0.06″, such as greater than or about 0.07″, such as greater than or about 0.08″, such as greater than or about 0.09″, such as greater than or about 0.1″, such as greater than or about 0.25″, such as greater than or about 0.5″, or any ranges or values therebetween. At such a point, it may be desirable to include one or more fillers in the first feedstock, forming a second feedstock, in order to provide strength and structure to the part while maintaining compatibility with the smooth, non-porous, exterior surface.

Thus, in embodiments, the reinforced feedstock may be utilized to form one or more second layers 510 (or second layers) at operation 610. The one or more second layers 510 may be formed in a plurality of horizontal layers within the one or more first layers 508, but it should be understood that, in embodiments, the one or more second layers 510 may also be deposited along the shape of platform 504/features 506. In embodiments, the one or more second layers 510 may also include additional features utilizing known printing geometry. For instance, the one or more second layers 510 may include printed mounting holes, alignment pins, channels, and the like as discussed above. In addition, while a generally straight surface is shown by the one or more second layers 510, it should be clear that the outer surface formed by the one or more second layers 510 may have any one or more of the contoured surfaces discussed above in regards to lower surface 236 and interior surface 240. Moreover, in embodiments, as will be discussed below, the one or more second layers 510 may instead utilize a feed material different that the first feed material, that is capable of forming a robust integral interface with the one or more first layers 508, with or without any reinforcing fillers. The one or more second layers 510 may be printed until a desired thickness is obtained, such as a thickness of a seal or polymeric part as known in the art, or sufficient to “fill in” the three-dimensional shape formed by the contoured printing.

The present disclosure has also surprisingly found that, unlike conventional seals and components, a lip, such as internal seal member 235 discussed above may be formed integrally with the monolithic seal. For instance, a softer thermoplastic elastomer may be selected that allows formation of a robust seal with a substrate, as discussed above, but that is also compatible with one or more second layers 510 and or one or more first layers 508. Thus, in embodiments, a third feed material may be applied, forming one or more third layers 512, over the one or more second layers 510 and/or one or more first layers 508 at operation 615. Namely, as discussed above, based upon the orientation of the one or more sloped features 506, and as illustrated in FIGS. 2A-2C, the one or more third layers may overlie a portion of the one or more first layers 508, the one or more second layers 510, or a combination thereof. While the one or more third layers 512 are shown in a stepped configuration, it should be clear that one or more third layers 512 may have any form discussed above in regards to internal seal member 235, as well as any orientation that allows a tight seal between contact pins 220 and substrate 206 from the electroplating bath. In addition, while the one or more third layers 512 are illustrated as only being deposited over a portion of the one or more first layer 508 and/or one or more second layers 510 (such as, e.g., within a first portion 243) extending from an inner annular edge 537 toward an outer annular edge 538 of features 506, in embodiments, the one or more third layers may be formed over the entirety of the one or more second layers 510, or may be formed over only the one or more first layers 508 at an annular inner edge 537.

In some embodiments the first feed material, second feed material, and/or third feed material (e.g., external seal member 230 and internal seal member 235 in embodiments), may be or include polymeric materials. In some embodiments, first feed material and/or second feed material (e.g., external seal member 230 in embodiments) may be a thermoplastic polymer, and third feed material (e.g., internal seal member 235 in embodiments) may be a thermoplastic elastomer. By utilizing such materials, a bonded structure may be formed. As previously explained, fluoroelastomers may often be used in components that contact a substrate, similar to the internal seal member of the present technology. The fluoroelastomers may not readily bond with the structural member of the seal, and thus an adhesive or other coupling mechanism may be employed. In some embodiments of the present technology the internal seal member 235 and/or the external seal member 230 may be free of fluorine, and the internal seal member 235 may be configured specifically to form a firmly printed bond with external seal member 230 during formation of the seal member 210 without the use of adhesives, as the present technology provides for the formation of a unitary body.

The first feed material, the second feed material, or both the first and second feed materials may include a polymeric material, and may include an organic repeating moiety that may include or consist of carbon and hydrogen. Some materials that may be used in the first feed material, the second feed material, or both the first and second feed materials may include polyethylene, polypropylene, polybutylene, polystyrene, or other polymeric components including thermoplastic polymeric materials.

To add structural rigidity, the second feed material can include a filler material. The filler material may be selected to be inert to electrolyte materials used in plating operations, and the filler material may also be insulative to limit conductivity to the seal, which may otherwise result in plating on the external seal member 230. Although any such compatible filler material may be included, in some embodiments the filler material may be or include glass, which may form a glass-filled polymeric material, such as glass-filled polypropylene, as one non-limiting example. The glass content may be adjusted to provide adequate reinforcement, but not so high a weight percentage that the feed material becomes abrasive. Thus, in embodiments, the filler material may be present in an amount of greater than or about 10 wt. %, such as greater than or about 12.5 wt. %, such as greater than or about 15 wt. %, such as greater than or about 17.5 wt. %, such as greater than or about 20 wt. %, such as greater than or about 22.5 wt. %, such as greater than or about 25 wt. %, such as greater than or about 27.5 wt. %, such as greater than or about 30 wt. %, but such as less than about 50 wt. %, such as less than or about 45 wt. %, such as less than or about 40 wt. %, or any ranges or values therebetween, based upon the weight of the respective layer formed from the reinforced feedstock. However, in embodiments, the first feed material may be generally free of fillers, in order to provide the desired surface finish.

The third feed material may also include a polymeric material, and may include any of the polymeric materials noted above. In some embodiments, the third feed material may be or include a thermoplastic elastomer. Exemplary materials may include polyolefin thermoplastic elastomers, and may include materials incorporating rubbers, including ethylene propylene diene monomer, as one non-limiting example. Thermoplastic vulcanizate may be used as the third feed material in some embodiments as well as styrene ethylene butylene styrene (SEBS). In some embodiments the printing of the one or more third layers 512 to the one or more second layers 510 may be performed at a temperature configured to produce an interphase between the first layer(s) second layer(s) and third layer(s). For example, polypropylene from the glass-filled polypropylene may be characterized by solubility with materials of the inner seal member, such as polypropylene when thermoplastic vulcanizate or SEBS may be used. Accordingly, a seal or component may be formed with a unitary body.

Layers formed from first feed material, the second feed material, and the third feed material may each be characterized by a hardness. For example, one or more layers formed from first feed material and/or second feed material may be characterized by a greater hardness to provide structural rigidity and support, while third feed material may be characterized by a lower hardness to allow a seal to be formed about a substrate included within the seal. For example, one or more layers formed from the third feed material may be characterized by a hardness on the Shore A scale of between about 10 and about 80, such as between about 30A and about 70A, between about 40A and about 65A, between about 50A and about 65A, as well as within any lesser range included within these ranges.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology. Additionally, methods or processes may be described as sequential or in steps, but it is to be understood that the operations may be performed concurrently, or in different orders than listed.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a model” includes a plurality of such models, and reference to “the targeted property” includes reference to one or more properties and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A monolithic electroplating seal comprising:
an external seal member comprising an inner annular radius, an outer annular radius, and an external seal member body defined between an exterior surface and an interior surface opposite the exterior surface, the exterior surface being formed from at least one polymer layer, the at least one polymer layer comprising a porosity of less than or about 10 vol. %, and wherein the external seal member body comprises a filler; and
an internal seal member formed integrally with and extending along at least a portion of the interior surface of the external seal member from the inner annular radius toward the outer annular radius, wherein the internal seal member comprises a deformable thermoplastic elastomer.

2. The monolithic electroplating seal of claim 1, wherein a portion of the exterior surface of the external seal member defines one or more sloped features.

3. The monolithic electroplating seal of claim 2, wherein the one or more sloped features have a slope from about 1° to about 45° relative to a second portion of the exterior surface of the external seal member.

4. The monolithic electroplating seal of claim 2, wherein the monolithic electroplating seal is additively manufactured.

5. The monolithic electroplating seal of claim 1, wherein at least one polymer layer forming the exterior surface comprises a thermoplastic polymer.

6. The monolithic electroplating seal of claim 1, wherein the external seal member body comprises a thermoplastic polymer and from about 10 wt. % to about 50 wt. % filler, based upon a weight of the external seal member body.

7. The monolithic electroplating seal of claim 1, wherein monolithic electroplating seal is generally free of adhesives and/or metal support members.

8. The monolithic electroplating seal of claim 1, wherein the exterior surface of the external seal member comprises polypropylene, the external seal member body comprises glass filled polypropylene, and the internal seal member comprises thermoplastic vulcanizate or styrene ethylene butylene styrene.

9. An electroplating system seal comprising:
an annular busbar comprising an inner annular radius and an outer annular radius, wherein the annular busbar comprises a plurality of contact extensions disposed along the inner annular radius;
an external seal member comprising an inner annular radius, an outer annular radius, and an external seal member body defined between an exterior surface and an interior surface opposite the exterior surface, the exterior surface being formed from at least one polymer layer, the at least one polymer layer comprising a porosity of less than or about 10 vol. %, and wherein the external seal member body comprises a filler; and
an internal seal member formed integrally with and extending along at least a portion of the interior surface of the external seal member from the inner annular radius toward the outer annular radius.

10. The electroplating system seal of claim 9, wherein the internal seal member and the external seal member form a monolithic seal body.

11. The electroplating system seal of claim 10, wherein the monolithic seal body is formed by additive manufacturing.

12. The electroplating system seal of claim 9, further comprising a backing plate.

13. The electroplating system seal of claim 12, wherein the annular busbar is disposed between the backing plate and at least a portion of the external seal member.

14. A method of forming a polymeric semiconductor system component, comprising:
printing a molten first feedstock along a top surface of a platen, forming at least one first layer; and
printing a second feedstock on the at least one first layer, forming at least one second layer;
wherein a portion of the top surface of the platen defines a sloped feature having a slope from about 1° to about 45° relative to a second portion of the top surface of the platen, and wherein the platen is formed from an inert material having a porosity of 10 vol. % or less.

15. The method of claim 14, wherein the platen further comprises a second sloped feature in a third portion spaced apart from the sloped feature, wherein the second sloped feature comprises a slope from about 1° to about 45° relative to the second portion of the top surface of the of platen.

16. The method of claim 14, wherein the first feedstock and the second feedstock are formed from different polymers that form a compatible interface.

17. The method of claim 14, wherein the first feedstock and the second feedstock are formed from the same polymer, wherein the second feedstock further comprises a filler.

18. The method of claim 14, wherein each first layer is printed such that each first layer comprises one or more sloped features that mirrors the top surface of the platen.

19. The method of claim 14, wherein the molten first feedstock is printed at a temperature from about 10° to about 70° greater than a melting point of a material forming the 2 first feedstock.

20. The method of claim 14, wherein the polymeric semiconductor system component is an electroplating seal, further comprising:
printing a third feedstock on a portion of the at least one second layer and/or the at least one first layer adjacent to an inner annular radius of the at least one second layer and/or the at least one first layer;
wherein:
the first feedstock comprises a thermoplastic polymer, and the at least one first layer comprises a porosity of 10 vol. % or less,
the second feedstock comprises a thermoplastic polymer and from about 10 wt. % to about 50 wt. % filler, based upon a weight of each second layer, and
wherein the third feedstock comprises thermoplastic vulcanizate or styrene ethylene butylene styrene.
